(19) United States
(12) Patent Application Publication
(10) Pub. No.: US 2025/0331021 A1
(43) Pub. Date: Oct. 23, 2025

(54) SCHEDULE ANNOUNCEMENT ENHANCEMENTS FOR COORDINATED TIME DIVISION MULTIPLE ACCESS

(71) Applicant: QUALCOMM Incorporated, San Diego, CA (US)

(72) Inventors: Sanket Sanjay KALAMKAR, San Diego, CA (US); Abhishek Pramod PATIL, San Diego, CA (US); Gaurang NAIK, San Diego, CA (US); Alfred ASTERJADHI, San Diego, CA (US); George CHERIAN, San Diego, CA (US); Sherief HELWA, San Diego, CA (US); Sai Yiu Duncan HO, San Diego, CA (US); Giovanni CHISCI, San Diego, CA (US)

(21) Appl. No.: 18/641,169

(22) Filed: Apr. 19, 2024

(51) Int. Cl. H04W 74/0816; H04W 74/04; H04W 74/08

(52) U.S. Cl. CPC H04W 74/0816; H04W 74/04; H04W 74/0866

(57) ABSTRACT

This disclosure provides methods, components, devices and systems for schedule announcement enhancements for coordinated time division multiple access (C-TDMA). Some aspects more specifically relate to a sharing AP indicating a schedule announcement for C-TDMA via a frame, such as a poll frame. The frame may include a query to determine interest of one or more shared APs to use a portion of a transmit opportunity (TXOP) obtained by the sharing AP or an indication allocating the portion of the TXOP to the shared APs. The sharing AP may receive a response to the frame via an associated poll response that may indicate an identifier of a shared AP. Various aspects relate more specifically to reallocating one or more fields in a poll frame to indicate information related to the shared TXOP.

### TECHNICAL FIELD

This disclosure relates generally to wireless communication and, more specifically, to schedule announcement enhancements for coordinated time division multiple access (C-TDMA).

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

In some WLANs, one or more wireless APs may participate in a coordinated AP (CAP) transmission scheme. One or more APs may use coordinated time division multiple access (C-TDMA) schemes to share time resources with one or more other APs. In some examples, an AP participating in a C-TDMA scheme may obtain a transmit opportunity (TXOP), and may determine to share a portion of the TXOP with one or more APs participating in the C-TDMA scheme. The AP that shares the TXOP may be referred to as a sharing AP, while an AP with which the TXOP is shared may be referred to as a shared AP. Accordingly, the sharing AP and the one or more shared APs may communicate with each other and associated wireless STAs during the TXOP. The sharing AP may transmit a schedule announcement frame indicating that the sharing AP may share the portion of the TXOP, and the shared APs may transmit a response (such as a clear to send (CTS) frame). In some examples, however, the sharing AP may transmit the schedule announcement frame during the TXOP, which may reduce a portion of the TXOP that may be used for other communications, and if the sharing AP does not receive the response (such as the CTS frame) to the schedule announcement frame, the TXOP may be otherwise unused. The response (such as the CTS frame) may additionally not differentiate between different shared APs and associated STAs that transmitted the response, and the sharing AP may as a result be unaware of which shared APs responded to the schedule announcement frame, among other challenges.

### SUMMARY

The systems, methods, and devices of this disclosure each have several innovative aspects, no single one of which is solely responsible for the desirable attributes disclosed herein.

One innovative aspect of the subject matter described in this disclosure can be implement in a method for wireless communications by a first wireless access point (AP). The method may include obtaining a transmit opportunity (TXOP), outputting, during the obtained TXOP and to a set of multiple wireless devices including at least one second wireless AP of a set of multiple second wireless APs, a first frame including an indication associated with sharing a portion of the obtained TXOP with the at least one second wireless AP of the set of multiple second wireless APs, the portion of the obtained TXOP being a shared TXOP for coordinated time division multiple access (C-TDMA) with the set of multiple second wireless APs, obtaining a response frame from the at least one second wireless AP of the set of multiple second wireless APs, the response frame including an identifier associated with the at least one second wireless AP, and sharing the portion of the obtained TXOP with the at least one second wireless AP for communication in accordance with obtaining the response frame including the identifier associated with the at least one second wireless AP.

Another innovative aspect of the subject matter described in this disclosure can be implemented in a first wireless AP for wireless communications. The first wireless AP may include a processing system that includes processor circuitry and memory circuitry that stores code. The processing system may be configured to cause the first wireless AP to obtain a TXOP, output, during the obtained TXOP and to a set of multiple wireless devices including at least one second wireless AP of a set of multiple second wireless APs, a first frame including an indication associated with sharing a portion of the obtained TXOP with the at least one second wireless AP of the set of multiple second wireless APs, the portion of the obtained TXOP being a shared TXOP for C-TDMA with the set of multiple second wireless APs, obtain a response frame from the at least one second wireless AP of the set of multiple second wireless APs, the response frame including an identifier associated with the at least one second wireless AP, and share the portion of the obtained TXOP with the at least one second wireless AP for communication in accordance with obtaining the response frame including the identifier associated with the at least one second wireless AP.

Another innovative aspect of the subject matter described in this disclosure can be implemented in another first wireless AP for wireless communications. The first wireless AP may include means for obtaining a TXOP, means for outputting, during the obtained TXOP and to a set of multiple wireless devices including at least one second wireless AP of a set of multiple second wireless APs, a first frame including an indication associated with sharing a portion of the obtained TXOP with the at least one second wireless AP of the set of multiple second wireless APs, the portion of the obtained TXOP being a shared TXOP for C-TDMA with the set of multiple second wireless APs, means for obtaining a response frame from the at least one second wireless AP of the set of multiple second wireless APs, the response frame including an identifier associated with the at least one second wireless AP, and means for sharing the portion of the obtained TXOP with the at least one second wireless AP for communication in accordance with obtaining the response frame including the identifier associated with the at least one second wireless AP.

Another innovative aspect of the subject matter described in this disclosure can be implemented in a non-transitory computer-readable medium storing code for wireless communications. The code may include instructions executable by one or more processors to obtain a TXOP, output, during the obtained TXOP and to a set of multiple wireless devices including at least one second wireless AP of a set of multiple second wireless APs, a first frame including an indication associated with sharing a portion of the obtained TXOP with the at least one second wireless AP of the set of multiple second wireless APs, the portion of the obtained TXOP being a shared TXOP for C-TDMA with the set of multiple second wireless APs, obtain a response frame from the at least one second wireless AP of the set of multiple second wireless APs, the response frame including an identifier associated with the at least one second wireless AP, and share the portion of the obtained TXOP with the at least one second wireless AP for communication in accordance with obtaining the response frame including the identifier associated with the at least one second wireless AP.

In some examples of the method, first wireless APs, and non-transitory computer-readable medium described herein, the first frame includes one or more fields, amongst a set of multiple receiver specific fields, intended for the at least one second wireless AP indicating the portion of the obtained TXOP.

In some examples of the method, first wireless APs, and non-transitory computer-readable medium described herein, the indication associated with sharing the portion of the obtained TXOP includes an indication of a SCS, an estimated timing of a TXOP allocation frame, an estimated length of the portion of the obtained TXOP, or an estimated length of the obtained TXOP, or any combination thereof.

In some examples of the method, first wireless APs, and non-transitory computer-readable medium described herein, an order of the set of multiple receiver specific fields may be based on respective wireless devices of the set of multiple wireless devices corresponding to respective receiver specific fields of the set of multiple receiver specific fields.

Another innovative aspect of the subject matter described in this disclosure can be implemented in a method for wireless communications by a first wireless AP. The method may include obtaining a first frame including an indication associated with sharing a portion of a TXOP obtained by a second wireless AP, the portion of the obtained TXOP being a shared TXOP for C-TDMA, outputting a response frame in response to the first frame, the response frame including an identifier associated with the first wireless AP, and communicating with one or more wireless stations during the portion of the obtained TXOP in accordance with outputting the response frame including the identifier associated with the first wireless AP.

Another innovative aspect of the subject matter described in this disclosure can be implemented in a first wireless AP for wireless communications. The first wireless AP may include a processing system that includes processor circuitry and memory circuitry that stores code. The processing system may be configured to cause the first wireless AP to obtain a first frame including an indication associated with sharing a portion of a TXOP obtained by a second wireless AP, the portion of the obtained TXOP being a shared TXOP for C-TDMA, output a response frame in response to the first frame, the response frame including an identifier associated with the first wireless AP, and communicate with one or more wireless stations during the portion of the obtained TXOP in accordance with outputting the response frame including the identifier associated with the first wireless AP.

Another innovative aspect of the subject matter described in this disclosure can be implemented in another first wireless AP for wireless communications. The first wireless AP may include means for obtaining a first frame including an indication associated with sharing a portion of a TXOP obtained by a second wireless AP, the portion of the obtained TXOP being a shared TXOP for C-TDMA, means for outputting a response frame in response to the first frame, the response frame including an identifier associated with the first wireless AP, and means for communicating with one or more wireless stations during the portion of the obtained TXOP in accordance with outputting the response frame including the identifier associated with the first wireless AP.

Another innovative aspect of the subject matter described in this disclosure can be implemented in a non-transitory computer-readable medium storing code for wireless communications. The code may include instructions executable by one or more processors to obtain a first frame including an indication associated with sharing a portion of a TXOP obtained by a second wireless AP, the portion of the obtained TXOP being a shared TXOP for C-TDMA, output a response frame in response to the first frame, the response frame including an identifier associated with the first wireless AP, and communicate with one or more wireless stations during the portion of the obtained TXOP in accordance with outputting the response frame including the identifier associated with the first wireless AP.

In some examples of the method, first wireless APs, and non-transitory computer-readable medium described herein, the first frame includes one or more fields, amongst a set of multiple receiver specific fields, intended for the first wireless AP indicating the portion of the obtained TXOP.

In some examples of the method, first wireless APs, and non-transitory computer-readable medium described herein, the indication associated with sharing the portion of the obtained TXOP includes an indication of a SCS, an estimated timing of a TXOP allocation frame, an estimated length of the portion of the obtained TXOP, or an estimated length of the obtained TXOP, or any combination thereof.

In some examples of the method, first wireless APs, and non-transitory computer-readable medium described herein, the indication associated with sharing the portion of the obtained TXOP includes a query to first wireless AP to use the portion of the obtained TXOP, an indication of allocating the portion of the obtained TXOP to the first wireless AP, or both.

### BRIEF DESCRIPTION OF THE DRAWINGS

FIG. 1 shows a pictorial diagram of an example wireless communication network.

FIG. 2 shows an example physical layer (PHY) protocol data unit (PPDU) usable for communication between a wireless access point (AP) and one or more wireless stations (STAs).

FIG. 3 shows a hierarchical format of an example PPDU usable for communication between a wireless AP and one or more wireless STAs.

FIG. 4 shows an example of a signaling diagram that supports schedule announcement enhancements for coordinated time division multiple access (C-TDMA).

FIG. 5 shows an example of a frame structure that supports schedule announcement enhancements for C-TDMA.

FIG. 6 shows an example of a process flow that supports schedule announcement enhancements for C-TDMA.

FIG. 7 shows a block diagram of an example wireless communication device that supports schedule announcement enhancements for C-TDMA.

FIGS. 8 through 11 show flowcharts illustrating example processes performable by or at a first wireless AP that supports schedule announcement enhancements for C-TDMA.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

In some wireless communication networks, an access point (AP) may participate in coordinated TDMA (C-TDMA) with one or more additional APs. For example, the AP may coordinate sharing of one or more resources (such as resources for communicating with one or more wireless stations (STAs)) with the one or more additional APs in a time domain. That is, each AP may obtain a transmit opportunity (TXOP), during which the obtaining AP may communicate with one or more other wireless devices, such as STAs. In some examples, an AP (such as a sharing AP) may not use a portion of an obtained TXOP, and may accordingly allocate the unused portion of the TXOP to one or more other APs (such as shared APs). The sharing AP may transmit a schedule announcement frame indicating that the sharing AP may share the portion of the TXOP, and the shared APs may transmit a response, such as a clear-to-send (CTS) frame. In some examples, however, the sharing AP may transmit the schedule announcement frame during the TXOP, which may reduce a portion of the TXOP that may be usable for other communication (such as data communication with STAs). Additionally, in examples in which the sharing AP does not receive a response to the schedule announcement frame, the TXOP may be unused, which may reduce an efficiency of resource allocation in the wireless communication system. The response (such as the CTS frame) may additionally not identify the shared AP that transmitted the response, and the sharing AP may therefore be unaware of which shared APs responded to the schedule announcement frame.

Various aspects relate generally to methods for a sharing AP to send a scheduling announcement indicating that the sharing AP may share the portion of a TXOP via a frame (such as a buffer status report poll (BSRP) frame, a basic trigger frame, a variant of a multi-user block address request (MU-BAR) trigger frame, or a multi-user request to send (MU-RTS) trigger frame, or another trigger frame). The frame may include a query to determine interest of one or more shared APs to use a portion of the TXOP obtained by the sharing AP or an indication allocating the portion of the TXOP to the shared APs. The sharing AP may receive responses to the frame via an associated response (such as a buffer status report (BSR), an MU-RTS, or an MU-BAR) that may indicate an identifier of the shared AP (such as via a transmitter address of the shared AP). Various aspects relate more specifically to reallocating one or more fields in a schedule announcement frame to indicate information related to the shared TXOP, such as a stream classification service (SCS) identifier (ID) of traffic to be served within the TXOP, a time of a TXOP allocation frame, and a length of the obtained TXOP, a length of the shared portion of the TXOP, among other aspects.

Particular aspects of the subject matter described in this disclosure may be implemented to realize one or more of the following potential advantages. The techniques employed by the described wireless communication devices may provide increased efficiency in resource allocation. For example, operations performed by the described wireless communication devices may provide improvements to resource allocation by enabling relatively more wireless communication devices to share a TXOP as a result of transmitting a response to a frame sent by a sharing AP (such as respective poll frames sent by respective multiple candidate shared APs). The described techniques may result in increased efficiency by increasing a likelihood that a C-TDMA frame exchange is successful, which may enable relatively more devices to communicate during an obtained TXOP. In some implementations, the operations performed by the described wireless communication devices include identifying which candidate shared APs and associated STAs that responded to the poll frame, thereby enabling enhanced multilink single-radio (EMLSR) communication that may have a relatively higher efficiency of resource usage, among other benefits.

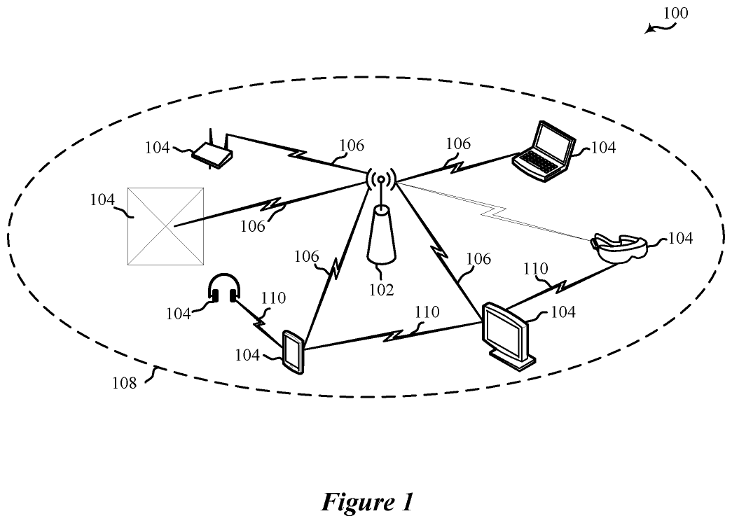

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communication (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHz, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHz-24.25 GHZ), FR4a or FR4-1 (52.6 GHz-71 GHz), FR4 (52.6 GHz-114.25 GHz), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communication or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communication over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (such as detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communication spanning operating bandwidths of 20 MHZ, 40 MHz, 80 MHz, 160 MHz, 240 MHz, and 320 MHz while an UHR system may enable communication spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

Transmitting and receiving devices AP 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various quality of service (QOS) parameters. For example, existing technology (such as IEEE 802.11ax standard amendment protocols) supports the use of up to 1024-QAM, where a modulated symbol carries 10 bits. To further improve peak data rate, each of the AP 102 or the STA 104 may employ use of 4096-QAM (also referred to as “4 k QAM”), which enables a modulated symbol to carry 12 bits. 4k QAM may enable massive peak throughput with a maximum theoretical PHY rate of 10 bps/Hz/subcarrier/spatial stream, which translates to 23 Gbps with 5/6 LDPC code (10 bps/Hz/subcarrier/spatial stream*996*4 subcarriers*8 spatial streams/13.6 us per OFDM symbol). The AP 102 or the STA 104 using 4096-QAM may enable a 20% increase in data rate compared to 1024-QAM given the same coding rate, thereby allowing users to obtain higher transmission efficiency.

In some examples of the wireless communication network 100, one or more APs 102 may participate in C-TDMA schemes. For example, a sharing AP 102 may share a portion of a TXOP obtained by the sharing AP 102 with one or more shared APs 102. The sharing AP 102 may transmit a frame (such as a BSRP frame, a basic trigger frame, a variant of a MU-BAR trigger frame, a MU-RTS trigger frame, or another trigger frame) to one or more shared APs 102. The frame may include a query to determine interest of one or more shared APs 102 to use the portion of the TXOP or an indication allocating the portion of the TXOP to the shared APs 102. The sharing AP 102 may receive responses to the frame via an associated response frame (such as a BSR, a MU-RTS, a MU-BAR) that may indicate an identifier of a shared AP 102 (such as via a transmitter address of the shared AP 102). The sharing AP 102 may accordingly share the portion of the TXOP.

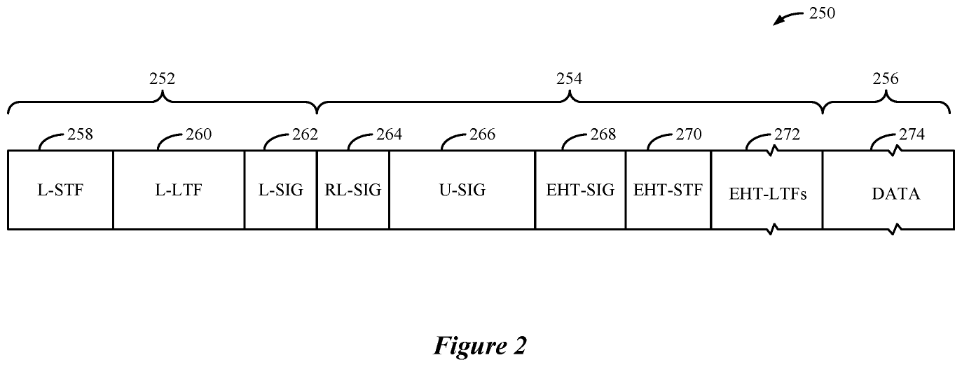

FIG. 2 shows an example physical layer (PHY) protocol data unit (PPDU) 250 usable for communication between a wireless AP and one or more wireless STAs. For example, the AP and STAs may be examples of the AP 102 and the STAs 104 described with reference to FIG. 1. As shown, the PPDU 250 includes a PHY preamble, that includes a legacy portion 252 and a non-legacy portion 254, and a payload 256 that includes a data field 274. The legacy portion 252 of the preamble includes an L-STF 258, an L-LTF 260, and an L-SIG 262. The non-legacy portion 254 of the preamble includes a repetition of L-SIG (RL-SIG) 264 and multiple wireless communication protocol version-dependent signal fields after RL-SIG 264. For example, the non-legacy portion 254 may include a universal signal field 266 (referred to herein as “U-SIG 266”) and an EHT signal field 268 (referred to herein as “EHT-SIG 268”). The presence of RL-SIG 264 and U-SIG 266 may indicate to EHT- or later version-compliant STAs 104 that the PPDU 250 is an EHT PPDU or a PPDU conforming to any later (post-EHT) version of a new wireless communication protocol conforming to a future IEEE 802.11 wireless communication protocol standard. One or both of U-SIG 266 and EHT-SIG 268 may be structured as, and carry version-dependent information for, other wireless communication protocol versions associated with amendments to the IEEE family of standards beyond EHT. For example, U-SIG 266 may be used by a receiving device (such as an AP 102 or a STA 104) to interpret bits in one or more of EHT-SIG 268 or the data field 274. Like L-STF 258, L-LTF 260, and L-SIG 262, the information in U-SIG 266 and EHT-SIG 268 may be duplicated and transmitted in each of the component 20 MHz channels in instances involving the use of a bonded channel.

The non-legacy portion 254 further includes an additional short training field 270 (referred to herein as “EHT-STF 270,” although it may be structured as, and carry version-dependent information for, other wireless communication protocol versions beyond EHT) and one or more additional long training fields 272 (referred to herein as “EHT-LTFs 272,” although they may be structured as, and carry version-dependent information for, other wireless communication protocol versions beyond EHT). EHT-STF 270 may be used for timing and frequency tracking and AGC, and EHT-LTF 272 may be used for more refined channel estimation.

EHT-SIG 268 may be used by an AP 102 to identify and inform one or multiple STAs 104 that the AP 102 has scheduled uplink (UL) or downlink (DL) resources for them. EHT-SIG 268 may be decoded by each compatible STA 104 served by the AP 102. EHT-SIG 268 may generally be used by the receiving device to interpret bits in the data field 274. For example, EHT-SIG 268 may include resource unit (RU) allocation information, spatial stream configuration information, and per-user (such as STA-specific) signaling information. Each EHT-SIG 268 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 274.

In some examples, a PPDU 250 may be used for C-TDMA as described herein. For example, a sharing AP 102 may transmit a frame indicating information related to sharing a portion of a TXOP with one or more shared APs 102. The sharing AP 102 may additionally, or alternatively, transmit the frame to one or more STAs 106. In some examples, the one or more STAs 106 may respond to the frame via a PPDU 250.

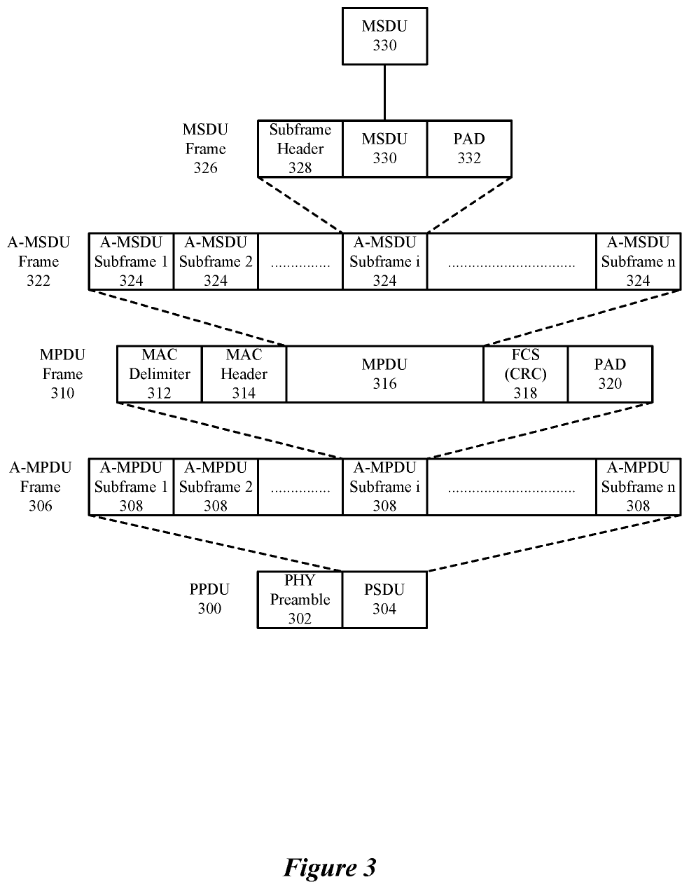

FIG. 3 shows a hierarchical format of an example PPDU usable for communication between a wireless AP and one or more wireless STAs. For example, the AP and STAs may be examples of the AP 102 and the STAs 104 described with reference to FIG. 1. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 306 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (such as the FCS field 318 may include a cyclic redundancy check (CRC)) and padding bits 320. The MPDU 316 may carry one or more MAC service data units (MSDUs) 316. For example, the MPDU 316 may carry an aggregated MSDU (A-MSDU) 322 including multiple A-MSDU subframes 324. Each A-MSDU subframe 324 may be associated with an MSDU frame 326 and may contain a corresponding MSDU 330 preceded by a subframe header 328 and, in some examples, followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body. The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 314 also includes one or more fields indicating addresses for the data encapsulated within the frame body. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields).

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of the wireless communication network 100 in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement spatial reuse techniques. For example, APs 102 and STAs 104 configured for communication using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communication with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communication among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

Retransmission protocols, such as hybrid automatic repeat request (HARQ), also may offer performance gains. A HARQ protocol may support various HARQ signaling between transmitting and receiving wireless communication devices (such as the AP 102 and the STAs 104 described with reference to FIG. 1) as well as signaling between the PHY and MAC layers to improve the retransmission operations in a wireless communication network. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a wireless communication network may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (such as a negative acknowledgment (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communication that employ ARQ with those that employ HARQ.

APs and STAs (such as the AP 102 and the STAs 104 described with reference to FIG. 1) that include multiple antennas may support various diversity schemes. For example, spatial diversity may be used by one or both of a transmitting device (such as either AP 102 or STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally or alternatively involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (such as in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (such as identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communication to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communications; that is, concurrent transmissions from one device to each of multiple devices (such as multiple simultaneous downlink communication from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHZ, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communication systems, an AP 102 may allocate or assign multiple RUs to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the EHT-SIG field for an EHT PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of EHT-SIG can be used to individually allocate RUs to the single user, thereby avoiding the punctured channels. In some other examples, U-SIG may be used to indicate SU preamble puncturing. For example, the SU preamble puncturing may be indicated by a value of the EHT-SIG compression field in U-SIG.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHZ, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communication links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communication between MLDs in the same direction (such as all uplink or all downlink), while in some other examples or durations of time, two or more of the communication links may be used for communication in different directions (such as one or more communication links may support uplink communication and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (such as monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

A wireless communication device may include an auxiliary radio and a main radio and may operate in both an auxiliary radio mode and a main radio mode. The wireless communication device may be a STA or an AP, such as, for example, the AP 102 and STAs 104 described with reference to FIG. 1. Additionally, the wireless communication device may support communication over a single wireless link or over multiple wireless links. For example, the wireless communication device may be an AP MLD or a non-AP MLD. The auxiliary radio mode may support communication with relatively lower data rates (such as ≤24 Mbps) than the main radio mode. For example, while operating in an auxiliary radio mode, the auxiliary radio of the wireless communication device may transmit messages having a non-high throughput (non-HT) format whereas, while operating in a main radio mode, the main radio may transmit messages having an EHT, UHR or later protocol format. A wireless communication device that uses an auxiliary radio in addition to a main radio may improve reliability and reduce latency and power consumption. For example, the wireless communication device may improve reliability by using the auxiliary radio to transmit/receive redundancies, facilitate fast feedback exchanges, or otherwise increase robustness for high-priority or otherwise important packets (such as packets containing latency-sensitive traffic or traffic requiring high reliability). For example, to support latency-sensitive traffic insertion in uplink communications, an AP may utilize its auxiliary radio for detection of low latency PPDU (LL-PPDU) subframes associated with latency-sensitive traffic. As another example, the wireless communication device also may use the auxiliary radio to scan for channels while communicating on another channel via the main radio, thereby reducing latency associated with a transition between channels by eliminating the time for the main radio to scan for channels. As another example, use of the auxiliary radio may reduce power consumption by enabling the main radio to enter a sleep mode and monitoring for wake-up signals via the auxiliary radio, which is designed to consume less power than the main radio.

The auxiliary radio may support both transmitting and receiving (Tx/Rx) modes of operation, or may support receiving-only (Rx-only) modes of operation. If the wireless communication device is an MLD, the wireless communication device may communicate on one or more wireless links using a main radio and may simultaneously communicate on one or more wireless links using one or more auxiliary radios. In an MLD scenario in which the auxiliary radio is Rx-only capable (an “Aux-Rx” mode), the wireless communication device may transmit and receive communication on a first wireless link using the main radio but may simultaneously receive (but not transmit) communication on a second wireless link using the auxiliary radio. In an MLD scenario in which the auxiliary radio is Tx/Rx capable (an “Aux-Tx/Rx” mode), the wireless communication device may transmit and receive communication on a first wireless link using the main radio and may simultaneously transmit and receive communication on a second wireless link using the auxiliary radio. In an MLD scenario, the wireless communication device may transition the main radio from a second wireless link to a first wireless link and may correspondingly transition the auxiliary radio from the first wireless link to the second wireless link. For example, the wireless communication device's auxiliary radio may receive control signaling on the second wireless link from another wireless communication device that triggers the wireless communication device to switch the use of its radios between wireless links. If the wireless communication device is not an MLD, the wireless communication device may transition from using its auxiliary radio to using its main radio mode on a single wireless link. For example, the wireless communication device's auxiliary radio may receive control signaling from another wireless communication device that triggers the wireless communication device to initiate the transition from use of the auxiliary radio to the main radio on the wireless link. Upon such a transition, the wireless communication device may place the auxiliary radio in a powered-down sleep state while activating the main radio to an awake state. Similarly, the wireless communication may transition from using its main radio to its auxiliary radio on the wireless link upon receiving a triggering control signal.

In some examples, the wireless communication device (such as a STA) may indicate (such as via a broadcast frame such as a beacon frame or other management frame), to other wireless communication devices (such as an AP), parameters associated with an auxiliary radio mode or parameters associated with transitioning from the auxiliary radio mode to a main radio mode for a given wireless link. For example, the wireless communication device may indicate a message format for the auxiliary radio mode. The indicated message format may be associated with a particular PPDU format (such as non-HT) or a supported data rate (such as ≤24 Mbps).

In some examples, the wireless communication device may indicate transition delays corresponding to time durations associated with switching from the auxiliary mode to the main radio mode as well as switching from the main radio mode to the auxiliary radio mode for a wireless link. A second wireless communication device may schedule data communication with the wireless communication device based on the transition delay so that data is not transmitted to the wireless communication device during the transition delay, during which data may be lost. The duration of the transition delay may generally be dependent on whether the auxiliary radio supports Tx/Rx or Rx-only modes of operation. For example, if the auxiliary radio supports Tx/Rx, the auxiliary radio may transmit an acknowledgment message in response to a request to transition to the main radio mode for a wireless link, which may extend the transition delay. Additionally, or alternatively, the duration of the transition delay may depend on whether the main radio is transitioning from a sleep mode or from a different wireless link.

The auxiliary radio may perform additional functions while the wireless communication device communicates with a second wireless communication device via a wireless link using the main radio. The particular functions that may be performed may generally depend on whether the auxiliary radio supports Tx/Rx or Rx-only modes of operation or whether the wireless communication device is an MLD capable of supporting communication over more than one wireless link. For example, in an Aux-Rx mode, the auxiliary radio of a wireless communication device (such as a non-AP MLD) may monitor or collect channel state (or quality) information or statistics (such as BSS load, interference profiles of neighboring BSSs and multi-NAV multi-primary maintenance) in a passive manner. In an Aux Tx/Rx mode, the auxiliary radio of the non-AP MLD may monitor or collect channel state information or statistics as well as transmit a report to an AP MLD that includes the collected channel state information or statistics without involvement of the main radio. In some examples, while operating in an Aux-Rx mode, a first wireless communication device (such as an AP MLD) may use the auxiliary radio to receive control communication or high-priority or otherwise important data communication from the second wireless communication device (such as another AP MLD) using a second wireless link while its main radio uses the first wireless link to perform data transfer. In contrast, in an Aux-Tx/Rx mode, an AP MLD may use the auxiliary radio to both receive and transmit control communication or high-priority or otherwise important data communications. In some examples, while operating in an Aux-Rx mode, a non-AP MLD's auxiliary radio may monitor or scan for potential APs to associate with on alternative wireless channels than the wireless channel on which the non-AP MLD's main radio is still communicating with a previously connected AP. In an Aux-Tx/Rx mode, an MLD may use the auxiliary radio to both scan for and perform association or authentication on other wireless channels.

In some environments, locations, or conditions, a regulatory body may impose a power spectral density (PSD) limit for one or more communication channels or for an entire band (such as the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communication Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of the wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (such as duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communication because benefits to addressing PSD limits may only be present for uplink communications.

In some examples, one or more coordinated APs 102 may participate in a C-TDMA scheme. For example, a sharing AP 102 may share a portion of a TXOP obtained by the sharing AP 102 with one or more shared APs 102. The sharing AP 102 may transmit a frame (such as a BSRP frame, a basic trigger frame, a variant of a MU-BAR trigger frame, an MU-RTS trigger frame, or another trigger frame) to one or more shared APs 102. The frame may include a query to determine interest of one or more shared APs 102 to use the portion of the TXOP or an indication allocating the portion of the TXOP to the shared APs 102. The sharing AP 102 may receive responses to the frame via an associated response frame (such as a BSR, CTS, block acknowledgement (BA)) that may indicate an identifier of a shared AP 102 (such as via a transmitter address of the shared AP 102). The sharing AP 102 may accordingly share the portion of the TXOP.

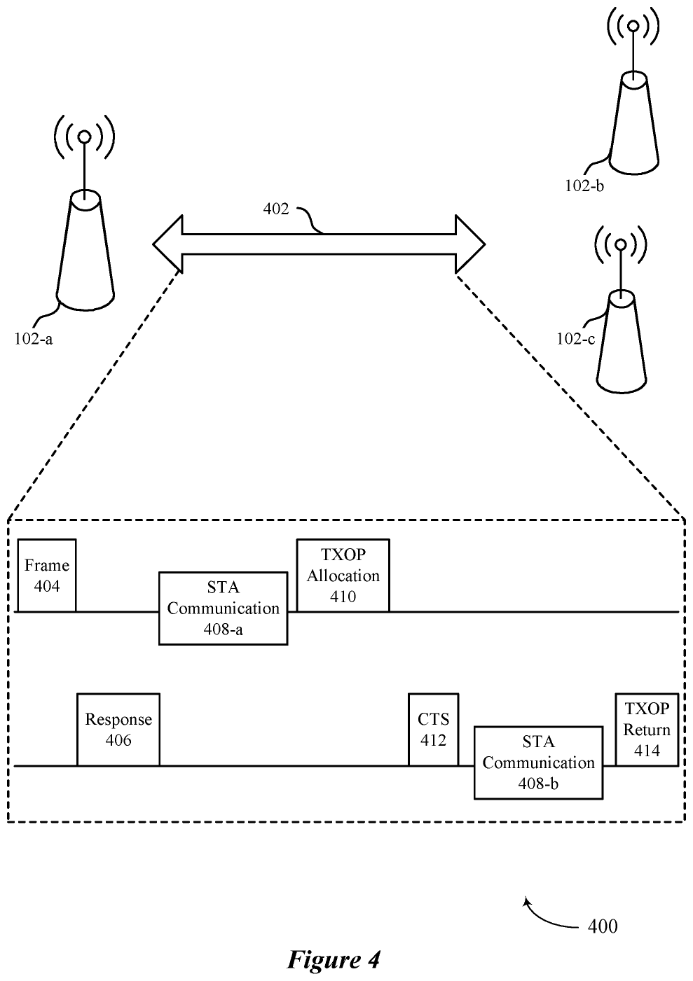

FIG. 4 shows an example of a signaling diagram 400 that supports schedule announcement enhancements for C-TDMA. The signaling diagram 400 may implement or may be implemented by aspects of the wireless communication network 100 or the PPDU 250. For example, the signaling diagram 400 may include one or more APs 104 (such as an AP 102-a, an AP 102-b, an AP 102-c) and one or more STAs 104, which may be examples of the corresponding devices as described with reference to FIG. 1.

In some examples of the signaling diagram 400, an AP 102-a may obtain (such as own) a TXOP. For a C-TDMA scheme, the AP 102-a (such as the sharing AP 102) may share a portion of the obtained TXOP time with one or more shared APs 102 (such as an AP 102-b, an AP 102-c). Such techniques may reduce latency by enabling multiple APs 102 to transmit during a given TXOP. The C-TDMA techniques may additionally, or alternatively, reduce contention and collisions between the APs 102 by enabling the APs 102 to coordinate access to TXOPs.

In some examples, the AP 102-a may transmit a schedule announcement frame at the beginning of the obtained TXOP indicating to one or more shared APs 102 that the AP 102-a may share the portion of the TXOP. The AP 102-a may therefore identify the shared APs 102 (such as APs 102 that may use the shared portion of the TXOP) among one or more candidate shared APs 102. The AP 102-a may additionally, or alternatively, identify one or more in-BSS STAs 104 of the AP 102-a. For example, the AP 102-a may use the schedule announcement frame to identify examples in which one or more STAs 104 will communicate with the AP 102-a during the obtained TXOP.

Additionally, or alternatively, the schedule announcement may prepare the shared APs 102 to make appropriate scheduling decisions (such as scheduling communication with STAs 104) based on sharing the portion of the TXOP. For example, the schedule announcement may indicate to the shared APs 102 a traffic priority for which the shared TXOP may be used (such as what kind of traffic the shared APs 102 may transmit during the shared TXOP). An upfront notification from the sharing AP 102 to the shared APs 102 via schedule announcement may provide the shared APs 102 sufficient time to pick the clients of the shared APs 102 that the APs 102 may serve during the shared TXOP. The shared APs 102 may make scheduling decisions based on a duration of the shared TXOP, an estimated start time of the shared TXOP (such as a timing of a TXOP allocation frame), the allowed traffic priority, and/or the identified suitable clients for the shared APs 102 to serve during the shared TXOP.

Additionally, or alternatively, the schedule announcement may enable the shared APs 102 to manage in-BSS transmissions (such as based on an estimated time at which the shared TXOP may be allocated to the shared APs 102). For example, during a time between the schedule announcement and the TXOP allocation, the shared APs 102 may manage uplink access from in-BSS STAs 104 (such as STAs 104 that may be hidden from the BSS of the sharing AP 102-a).

In some examples, the AP 102-a may use a type of frame (such as an MU-RTS frame) to indicate the schedule announcement. For example, the AP 102-a may use a framework (such as an extremely high throughput (EHT) triggered TXOP sharing (TXS) framework) to transmit the schedule announcement frame. In such TXS frameworks, as part of a frame exchange sequence, the sharing AP 102-a may transmit a schedule announcement frame (such as an MU-RTS frame) to a target shared AP 102 (such as an AP 102 participating in C-TDMA that the AP 102-a determines to share the TXOP with) indicating the portion of the TXOP that the sharing AP 102-a may share. The target shared AP 102 may respond to the schedule announcement frame with a control response (CTR) frame, which may indicate to the sharing AP 102-a that the target shared AP 102 will use the portion of the TXOP. The sharing AP 102-a may use a first portion of the TXOP to communicate with one or more STAs 104 served by the sharing AP 102-a. The sharing AP 102-a may transmit a TXOP allocation frame (such as a MU-RTS TXS frame) to the shared AP 102 to trigger TXOP sharing with the shared AP 102. The shared AP 102 may respond to the TXOP allocation frame with a CTS frame and may accordingly use the shared portion of the TXOP to communicate with one or more STAs 104 served by the shared AP 102. The sharing AP 102-a may reclaim any unused portion of the TXOP (if any) by receiving a TXOP return frame from the shared AP 102.

However, such TXS framework may result in relatively less efficient resource allocation than some other techniques. For example, because the AP 102-a may transmit the schedule announcement frame during the obtained TXOP, the schedule announcement frame and corresponding response frame (such as CTR frame) may reduce a time available during the TXOP for data transmissions to and from STAs 104. Additionally, in examples in which an intended entity (such as the target shared AP 102) does not respond to the schedule announcement (if the sharing AP 102-a transmits the schedule announcement to a single entity, such as target shared AP 102), the TXOP may be lost or unused.

Further, the sharing AP 102-a may not differentiate between multiple CTS responses (such as each CTS response may be identical). For example, in examples in which the AP 102-a solicits a response to the schedule announcement frame from multiple entities (such as multiple candidate shared APs 102), the sharing AP 102-a may not determine which shared AP 102 transmitted a corresponding CTS. This ambiguity in CTS responding also may not enable EMLSR, as the sharing AP 102-a may not know which candidate shared APs 102 and associated EMLSR STAs responded to the schedule announcement (such as MU-RTS frame).

Accordingly, techniques described herein may enable the sharing AP 102-a to transmit a frame 404 (such as a poll frame, a BSRP trigger frame, an MU-BAR trigger frame, an MU-RTS trigger frame, a basic trigger frame, a variant of a trigger frame such as an MU-RTS frame) to multiple candidate shared APs 102 (such as an AP 102-b, an AP 102-c). The frame 404 may result in relatively less overhead than some other frames that may solicit responses from multiple responders (such as multiple APs 102 such as OBSS AP 102, one or more in-BSS STAs 104, or both). For example, the frame 404 may solicit responses from both APs 102 and STAs 104, which may improve efficiency of the network. The frame 404 may enable use of the shared TXOP in examples in which one or more APs 102 do not respond to the frame, which may improve a chance of a successful frame exchange (due to the frame soliciting responses from multiple APs 102). In some examples, a response from the STAs 104 may be a BSR that indicates buffer status information. The format of the BSR may be a same format or a different format as BSR reports triggered by a non-schedule announcement BSRP.

The frame 404 may additionally, or alternatively, be compatible with EMLSR traffic, which may reduce overhead in a wireless communication network. For example, the frame 404 may be a BSRP trigger frame, which is an allowed trigger frame for EMLSR polling. Accordingly, the frame 404 may invite one or more in-BSS EMLRS STAs served by the AP 102-a to perform frame exchanges on an associated link.

The frame 404 may additionally, or alternatively, function as a short NAV. For example, the schedule announcement indicated by the frame 404 may set a NAV until the AP 102-a performs STA communication 408-a (such as until a first frame in the in-BSS from the AP 102-a). Some STAs 104 may sense that the wireless medium is busy (such as until a SIFS after a trigger-based (TB) PPDU). After the SIFS, the STAs 104 served by the AP 102-a may receive the STA communication 408-a. That is, the medium may be occupied by in-BSS transmissions from the AP 102-a.

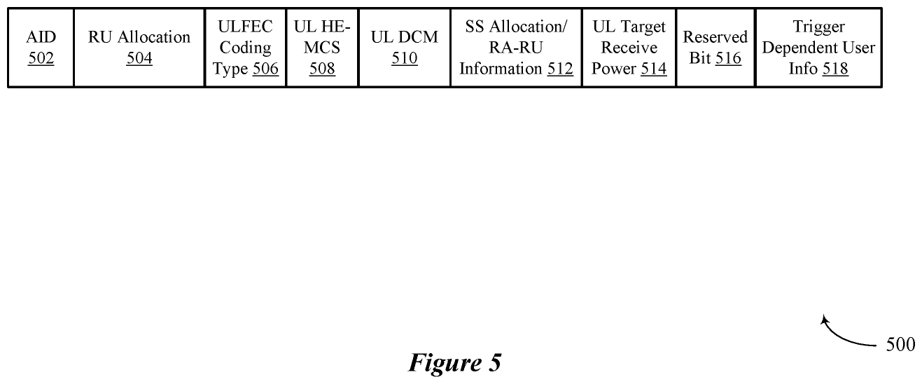

The frame 404 may include information related to sharing a portion of a TXOP obtained by the AP 102-a, such as a query requesting information (such as to determine interest of the shared APs 102 to use the portion of the TXOP), an indication allocating the portion of the TXOP to the shared APs 102, an SCS of traffic to be served within the shared portion of the TXOP, an estimated time of a TXOP allocation frame allocating the portion of the TXOP to the shared APs 102, an estimated length of the shared portion of the TXOP, an overall length of the obtained TXOP, and so on. The frame 404 is described in further detail with reference to FIG. 5. The AP 102-a may transmit the frame via a channel 402 (such as a link between the AP 102-a, the AP 102-b, and the AP 102-c). In some examples, the AP 102-a may transmit the frame 404 to one or more additional wireless devices, such as one or more STAs 104 served by the AP 102-a. In such examples, the frame may indicate one or more RUs allocated for a response (such as a PPDU) from the one or more STAs 104.

The AP 102-a may monitor for a response frame 406 (such as a CTR frame, a BSR, another frame triggered by the frame 404) from the AP 102-b and the AP 102-c. For example, the frame 404 may solicit responses 406 that identify the responding device. That is, a response 406 to the frame 404 may include information (such as a transmitter address (TA)) that identifies the device (such as the AP 102) that transmitted the response 406. Additionally, or alternatively, the APs 102 may transmit the responses 406 via distinct RUs (such as RUs assigned by the AP 102-a). The AP 102-a may therefore identify which devices (such as APs 102, STAs 104) have responded to the frame 404 and which devices did not respond to the frame. In some examples, the response 406 may be or include a response frame 406 from the APs 102 may be a BSR that indicates buffer status information. The format of the BSR may be a same format or a different format as BSR reports triggered by a non-schedule announcement BSRP.

In some examples, the response 406 may include a binary response. For example, polled APs 102 (such as the AP 102-b, the AP 102-c) may provide an accept/reject response. As an illustrative example, the AP 102-b and/or the AP 102-c may use a BSR or QoS control format. The AP 102-b and/or the AP 102-c may indicate a refusal of TXOP sharing by indicating all 0s in one or more control fields (such as BSR control fields or in a queue size field of a QoS control frame). The AP 102-b and/or the AP 102-c may indicate a refusal of TXOP sharing in examples in which the length of the shared TXOP is shorter than a duration used by the APs 102 for communicating with associated STAs or in examples in which the shared TXOP occurs beyond an expiration of low latency (LL) traffic of the APs 102. Accordingly, a format of a response to the frame 404 from an AP 102 may be different from a format of a response to the frame 404 from an STA 104. The AP 102-b and/or the AP 102-c may indicate an acceptance of TXOP sharing by indicating nonzero bits in the one or more control fields (such as a default or regular use of the BSR control fields or the queue size field). In some examples, if the response 406 is a BSR (such as indicating aggregate buffer status information), the AP 102-a may derive information from a buffer indication in the response 406 (such as if the responding AP 102 may use the full shared TXOP or if the AP 102-a may expect early return of the shared TXOP).

Additionally, or alternatively, the response frame may provide additional information. For example, the AP 102-b and/or the AP 102-c may provide an indication of early termination of TXOP sharing via the response 406 (such as via a time at which the AP 102-b and/or the AP 102-c expect to finish the use of the shared TXOP). As an illustrative example, the AP 102-b and/or the AP 102-c may repurpose one or more fields in a BSR or QoS control format or in a different format. The AP 102-b and/or the AP 102-c may indicate a refusal of TXOP sharing by indicating all 0s in one or more control fields (such as BSR control fields or in a queue size field of a QoS control frame). The AP 102-b and/or the AP 102-c may indicate a bandwidth time product (such as via the BSR control fields or the queue size field) to indicate acceptance of TXOP sharing. The AP 102-a may determine if the AP 102-b and/or the AP 102-c may return the TXOP early based on the bandwidth time product.

In some examples, the AP 102-a may perform one or more operations based on the response 406. For example, the AP 102-a may reorganize sharing of the TXOP based on the received responses. In some examples, the AP 102-a may withdraw sharing from one or more APs 102 (such as in examples in which one or more other APs 102 have higher priority traffic to transmit during the shared TXOP). The AP 102-a may determine a schedule for sharing the shared TXOP (such as including time and frequency resources that each AP 102 may use to perform STA communication 408-b during the shared TXOP). The AP 102-a may output the schedule to the AP 102-b and the AP 102-c via one or more RUs (such as RUs in a downlink PPDU) during in-BSS downlink (such as while performing STA communication 408-a). The one or more RUs may include a dedicated RU per polled AP 102 or a broadcast RU for C-TDMA. The AP 102-b and the AP 102-c may accordingly monitor the in-BSS transmissions of the AP 102-a.

The AP 102-a may perform STA communication 408-a (such as in-BSS transmissions to one or more STAs 104 served by the AP 102-a) and may transmit a TXOP allocation 410 to the AP 102-b and/or the AP 102-c to share the TXOP with the AP 102-b and/or the AP 102-c. In some examples (such as for multi-AP 102 sharing), if any AP 102 refused the TXOP, the AP 102-a may transmit a TXOP allocation frame to the AP 102 that refused the TXOP. For example, if the AP 102-b refused TXOP sharing, the AP 102-a may transmit a TXOP allocation frame to the AP 102-b, wait for a duration CTSTimeout, and perform point coordination function (PCF) interframe space (PIFS) recovery before transmitting a TXOP allocation 410 to another AP 102 (such as the AP 102-c).

In some examples, if any AP 102 refused the TXOP, the AP 102-a may adjust a TXOP sharing schedule. For example, in examples in which an intermediate AP 102-b (such as an AP 102-b scheduled to share the TXOP before one or more other APs 102) refuses or withdraws the shared TXOP, the AP 102-a may use the portion of the TXOP allocated for the AP 102-b (in examples in which the AP 102-a has pending in-BSS traffic) or reorganize the schedule such that another AP 102 may communicate during the portion of the TXOP allocated for the AP 102-b. In examples in which a last AP 102-c (such as an AP 102-c scheduled to share the TXOP after all other APs 102) refuses or withdraws the shared TXOP, the AP 102-a may use the portion of the TXOP allocated for the AP 102-c (in examples in which the AP 102-a has pending in-BSS traffic) or let the TXOP terminate. In such examples, in examples in which a NAV is short, the AP 102-a may not transmit a TXOP return frame (such as a CF-END or management frame such as a public action frame) to terminate the TXOP. In examples in which the NAV is not short, the AP 102-a may transmit a TXOP return frame to reset the NAV for neighboring STAs 104. In some examples, the AP 102-a may transmit a TXOP return regardless of a NAV setting (such as to indicate TXOP return information and information related to how the AP 102-a used the TXOP). For example, the TXOP return may indicate whether the AP 102-a changed a bandwidth for in-BSS STAs 104, or may carry (or piggyback) other information (such as C-TDMA parameters that may impact future sharing).

The AP 102-b and/or the AP 102-c may transmit a CTS 412 in response to the TXOP allocation 410. The AP 102-b and/or the AP 102-c (such as an AP 102 to which the AP 102-a transmitted the TXOP allocation 410) may perform STA communication 408-b via the shared portion of the TXOP. Following the STA communication 408-b, the shared AP 102 may transmit a TXOP return 414 (such as a CF-END or management frame such as a public action frame) to the AP 102-a to return the TXOP. In some examples (such as for single-AP 102 sharing or in examples in which the shared AP 102 is a last AP 102 scheduled to use the shared TXOP), in examples in which the shared AP 102 using the TXOP returns the TXOP sooner than expected (such as or refuses or withdraws the shared TXOP), the AP 102-a may use the portion of the TXOP allocated for the shared AP 102 (in examples in which the AP 102-a has pending in-BSS traffic) or let the TXOP terminate. In such examples, in examples in which a NAV is short, the AP 102-c may not transmit a TXOP return 414 to terminate the TXOP. In examples in which the NAV is not short, the AP 102-c may transmit a TXOP return 414 to reset the NAV for neighboring STAs 104. In some examples, the AP 102-c may transmit a TXOP return regardless of a NAV setting (such as to indicate TXOP return information and information related to how the AP 102-c used the TXOP). For example, the TXOP return may indicate whether the AP 102-c changed a bandwidth for in-BSS STAs 104, or may carry (or piggyback) other information (such as C-TDMA parameters that may impact future sharing).

FIG. 5 shows an example of a frame structure 500 that supports schedule announcement enhancements for C-TDMA. The frame structure 500 may implement or may be implemented by aspects of the wireless communication network 100, the PPDU 250, or the signaling diagram 400. For example, the frame structure 500 may be implemented by an AP 102, which may be an example of the corresponding device as described with reference to FIG. 1.

In some examples, as described with reference to FIG. 4, a sharing AP 102 may transmit a frame (such as a poll frame, a BSRP frame, an MU-BAR trigger frame, an MU-RTS trigger frame, a basic trigger frame, another trigger frame) to one or more shared APs 102 to indicate information related to sharing a portion of a TXOP obtained by the AP 102 (such as information pertaining to C-TDMA). The information may include a query requesting information (such as to determine interest of the shared APs 102 to use the portion of the TXOP), an indication allocating the portion of the TXOP to the shared APs 102, an SCS of traffic to be served within the shared portion of the TXOP, an estimated time of a TXOP allocation frame allocating the portion of the TXOP to the shared APs 102, an estimated length of the shared portion of the TXOP, an overall length of the obtained TXOP, and so on.

In some examples, the sharing AP 102 may indicate the information via one or more fields in the frame (such as receiver-specific fields). The one or more fields may be user information fields. In some examples, the sharing AP 102 may repurpose one or more user information fields (such as examples in which the user information fields comprise fewer reserved bits 516 than a quantity of bits used by the sharing AP 102 to indicate the information). For example, values of one or more user information fields may be fixed (such as may be known by the shared APs 102). Accordingly, the sharing AP 102 may use one or more fields allocated for indicating the fixed values to instead indicate the information for C-TDMA.

In some aspects, the sharing AP 102 may include the C-TDMA information (or additional C-TDMA information) via an additional user information field (such as a trigger dependent user information field carrying a same AID as the sharing AP 102). The sharing AP 102 may indicate the presence of the additional user information field using a bit in a preceding user information field (such as in a reserved subfield or one or more other subfield, such as a repurposed user information subfield).

In some examples, the frame may include a modified AID value to indicate the additional user information field (such as an extension of the user information field). For example, a first user information field may include an AID of a first shared AP 102 (such as assigned by the sharing AP 102 or determined by a predetermined method), and subsequent user information fields may include the modified AID value to indicate that information in the subsequent user information fields is an extension of the preceding user information field meant for the first shared AP 102.

In some examples, the frame may include a plurality of receiver-specific fields (such as fields specific to each shared AP 102). In such examples, the AP 102 may cluster user information fields meant for a same shared AP 102 together in the frame. In some examples, the sharing AP 102 may transmit the user information fields in an order corresponding to a type of device for which the user information fields carry information. For example, a first set of user information fields may be information for STAs 104, and a second set of user information fields may be information for APs 102. In some examples, the fixed values may be defined in a technical standard. In some examples, the fixed values may be negotiated between the coordinated APs 102 in examples in which C-TDMA is initiated. In such examples, the coordinated APs 102 may update the fixed values (such as part of a critical update mechanism).

As an illustrative example, the AP 102 may use one or more user information subfields of a BSRP frame to indicate the information. As illustrated with reference to FIG. 5, the user information fields of the BSRP frame may include an AID field 502 (such as with 12 bits), an RU allocation field 504 (such as with 8 bits), an UL forward error correction (FEC) coding type field 506 (such as with one bit), an UL high efficiency (HE) modulation and coding scheme (MCS) field 508 (such as with four bits), an UL DCM field 510 (such as with one bit), a SS allocation/RA RU information field 512 (such as with 6 bits), an UL target receive power field 514 (such as with 7 bits), a reserved bit 516, and a trigger dependent user information field 518 (such as with a variable quantity of bits). In some examples, the trigger dependent user information field 518 may be present in examples in which the sharing AP 102 indicates the presence of the trigger dependent user information field 518 (such as via the reserved bit 516 or one or more other fields of the frame).

The sharing AP 102 and/or the shared APs 102 may identify fixed values for one or more fields of the user information fields. For example, an UL FEC coding type may be fixed (such as low-density parity check (LDPC) code), an UL HE-MCS may be fixed (such as any fixed MCS value), an UL DCM may be fixed (such as the APs 102 may be fixed to always use DCM), and an SS allocation may be fixed (such as the APs 102 may always use one SS). Accordingly, the sharing AP 102 may repurpose 12 bits of the user information fields (such as the bit of the UL FEC coding type field 506, the four bits of the UL HE-MCS field 508, the bit of the UL DCM field 510, the 6 bits of the SS allocation/RA RU information field 512) and the reserved bit 516 to indicate C-TDMA information (such as 8 bits to indicate the SCS ID). Additionally, or alternatively, the sharing AP 102 may use the trigger dependent user information field 518 to indicate the C-TDMA information (such as in examples in which the trigger dependent user information field 518 is indicated to be present by one or more other bits of the BSRP frame).

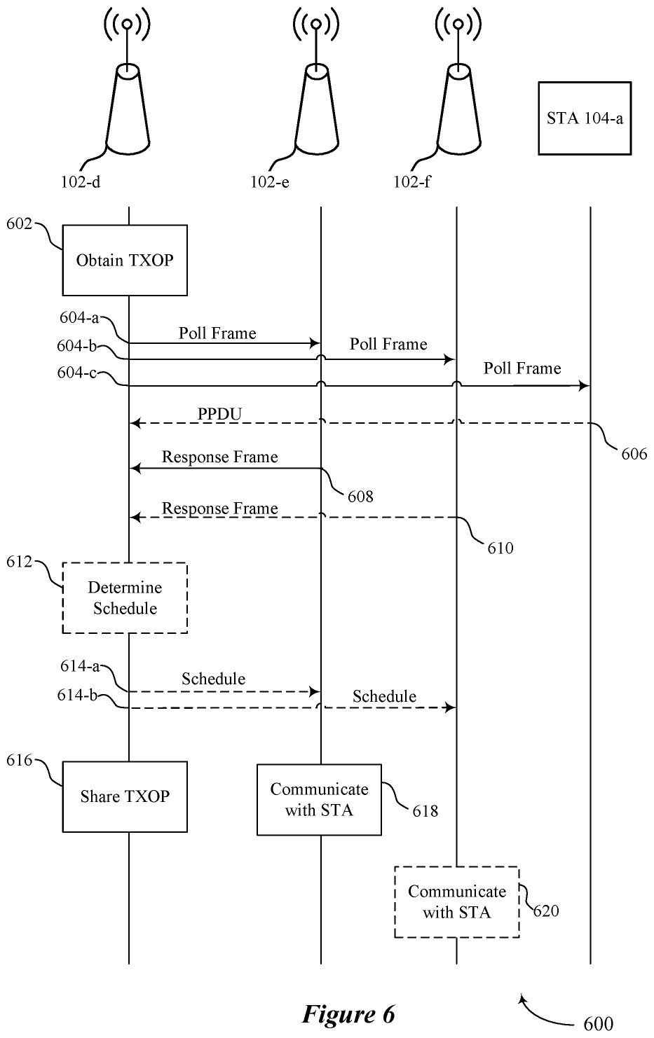

FIG. 6 shows an example of a process flow 600 that supports schedule announcement enhancements for C-TDMA. The process flow 600 may implement or may be implemented by aspects of the wireless communication network 100, the PPDU 250, the signaling diagram 400, or the frame structure 500. For example, the process flow 600 may include one or more APs 104 (such as an AP 102-d, an AP 102-e, an AP 102-f) and one or more STAs 104 (such as an STA 104-a), which may be examples of the corresponding devices as described with reference to FIG. 1.

In the following description of the process flow 600, the operations between the AP 102-d, the AP 102-e, the AP 102-f, and the STA 104-a may occur in a different order than the example order shown and, in some examples, may be performed by one or more different devices other than those shown as examples. Some operations also may be omitted from the process flow 600, and other operations may be added to the process flow 600. Further, although some operations or signaling may be shown to occur at different times for discussion purposes, these operations may actually occur at the same time.

At 602, the AP 102-d may obtain a TXOP. The AP 102-d may use part of the TXOP to communicate with one or more STAs 104 served by the AP 102-d (such as the STA 104-a). In some examples, the AP 102-d may not use a full duration of the TXOP. In such examples, the AP 102-d may determine to share a portion of the TXOP with one or more second APs 102 (such as the AP 102-e, the AP 102-f) that participate in a C-TDMA scheme with the AP 102-d. That is, the portion of the TXOP may be a shared TXOP for C-TDMA with the AP 102-e and the AP 102-f.

At 604-a, 604-b, and 604-c, the AP 102-d may output a first frame to one or more wireless devices (one or more second APs 102, such as the AP 102-e and the AP 102-f, and one or more STAs 104 served by the AP 102-d, such as the STA 104-a, respectively). In some examples, the first frame may be a BSRP frame, a basic trigger frame, an MU-RTS trigger frame, an MU-BAR trigger frame, a variant of one or more trigger frames, or another trigger frame. The first frame may include an indication of resources (such as an RU) allocated for a response to the first frame. The AP 102-d may output the first frame during the TXOP.

The first frame may include an indication associated with sharing the portion of the TXOP with the AP 102-e and the AP 102-f. For example, the frame may include a query requesting information (such as to determine interest of the shared APs 102 to use the portion of the TXOP), an indication allocating the portion of the TXOP to the shared APs 102, an SCS of traffic to be served within the shared portion of the TXOP, an estimated time of a TXOP allocation frame allocating the portion of the TXOP to the shared APs 102, an estimated length of the shared portion of the TXOP, an overall length of the obtained TXOP, and so on. In some examples, the first frame may indicate the portion of the obtained TXOP via one or more receiver-specific fields (such as user information fields that are intended for the AP 102-d or the AP 102-e).

In some examples, at 606, the one or more STAs 104 served by the AP 102-d may output a response frame (such as a frame comprising a trigger-based PPDU). For example, the response frame may include information (such as a BSR) triggered by the first frame. The STAs 104 may transmit the response frame together via the RU allocated within the first frame.

At 608, the AP 102-d may receive a response frame from the AP 102-e. The response frame may include an identifier (such as a TA) of the AP 102-e. In some examples, the response frame may indicate that the AP 102-e will communicate with one or more STAs 104 via the portion of the TXOP. In some examples, the response frame may indicate one or more resources (such as a duration, a bandwidth) via which the AP 102-e may communicate with the STAs 104 during the portion of the TXOP.

In some examples, based on the response frame, the AP 102-d may perform one or more actions. For example, the AP 102-d may serve one or more STAs 104 in the BSS of the AP 102-d within a portion of a bandwidth (such as a subchannel) if the AP 102-e indicates that the AP 102-e will use a different portion of the bandwidth. Additionally, or alternatively, the AP 102-d may share the TXOP with more or fewer APs 102 based on information indicated in the response (such as via different or same bandwidth parts, channels, or subchannels).

In some examples, at 610, the AP 102-d may receive a response frame from the AP 102-f. The response frame may include an identifier (such as a TA) of the AP 102-f. In some examples, the response frame may indicate that the AP 102-f will communicate with one or more STAs 104 via the portion of the TXOP. In some examples, the response frame may indicate one or more resources (such as a duration, a bandwidth) via which the AP 102-f may communicate with the STAs 104 during the portion of the TXOP.

In such examples, at 612, the AP 102-d may determine a schedule for the AP 102-e and the AP 102-f to communicate during the portion of the TXOP. For example, the AP 102-e may determine that the AP 102-e may use the portion of the TXOP during first time and frequency resources and that the AP 102-f may use the portion of the TXOP during second time and frequency resources. At 614-a and 614-b, the AP 102-d may output the schedule to the AP 102-e and the AP 102-f, respectively. The AP 102-a may indicate the schedule via one or more RUs of an in-BSS downlink transmission by the AP 102-d (such as dedicated RUs associated with the AP 102-e and the AP 102-f, a broadcast RU dedicated for C-TDMA).

At 616, the AP 102-d may share the portion of the TXOP with one or both of the AP 102-e and the AP 102-f. For example, the AP 102-d may output the TXOP allocation frame (such as at the estimated time indicated by the first frame). At 618, the AP 102-e may communicate with one or more STAs 104 served by the AP 102-e using the portion of the TXOP (such as according to the schedule) in accordance with outputting the response to the first frame. At 620, the AP 102-f may communicate with one or more STAs 104 served by the AP 102-f using the portion of the TXOP (such as according to the schedule).

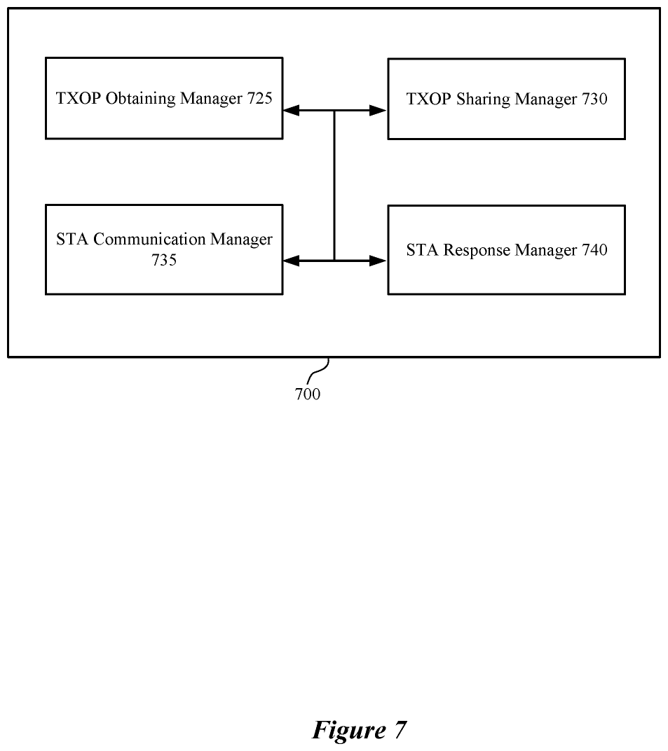

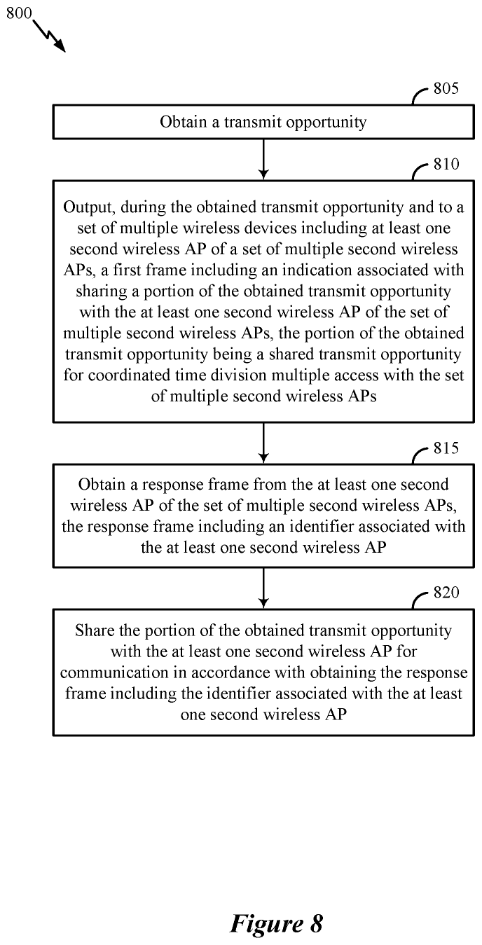

FIG. 7 shows a block diagram of an example wireless communication device 700 that supports schedule announcement enhancements for C-TDMA. In some examples, the wireless communication device 700 is configured to perform the processes 800, 900, 1000, and 1100 described with reference to FIGS. 8, 9, 10, and 11, respectively. The wireless communication device 700 may include one or more chips, SoCs, chipsets, packages, components or devices that individually or collectively constitute or include a processing system. The processing system may interface with other components of the wireless communication device 700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 700 may transmit the information output from the chip. In such an example, the second interface may refer to an interface between the processing system of the chip and a reception component, such that the wireless communication device 700 may receive information that is then passed to the processing system. In some such examples, the first interface also may obtain information, such as from the transmission component, and the second interface also may output information, such as to the reception component.

The processing system of the wireless communication device 700 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 700 can be configurable or configured for use in an AP, such as the AP 102 described with reference to FIG. 1. In some other examples, the wireless communication device 700 can be an AP that includes such a processing system and other components including multiple antennas. The wireless communication device 700 is capable of transmitting and receiving wireless communication in the form of, for example, wireless packets. For example, the wireless communication device 700 can be configurable or configured to transmit and receive packets in the form of physical layer PPDUs and MPDUs conforming to one or more of the IEEE 802.11 family of wireless communication protocol standards. In some other examples, the wireless communication device 700 can be configurable or configured to transmit and receive signals and communication conforming to one or more 3GPP specifications including those for 5G NR or 6G. In some examples, the wireless communication device 700 also includes or can be coupled with one or more application processors which may be further coupled with one or more other memories. In some examples, the wireless communication device 700 further includes at least one external network interface coupled with the processing system that enables communication with a core network or backhaul network that enables the wireless communication device 700 to gain access to external networks including the Internet.

The wireless communication device 700 includes a TXOP obtaining manager 725, a TXOP sharing manager 730, a STA communication manager 735, and a STA response manager 740. Portions of one or more of the TXOP obtaining manager 725, the TXOP sharing manager 730, the STA communication manager 735, and the STA response manager 740 may be implemented at least in part in hardware or firmware. For example, one or more of the TXOP obtaining manager 725, the TXOP sharing manager 730, the STA communication manager 735, and the STA response manager 740 may be implemented at least in part by at least a processor or a modem. In some examples, portions of one or more of the TXOP obtaining manager 725, the TXOP sharing manager 730, the STA communication manager 735, and the STA response manager 740 may be implemented at least in part by a processor and software in the form of processor-executable code stored in memory.

The wireless communication device 700 may support wireless communication in accordance with examples as disclosed herein. The TXOP obtaining manager 725 is configurable or configured to obtain a TXOP. The TXOP sharing manager 730 is configurable or configured to output, during the obtained TXOP and to a set of multiple wireless devices including at least one second wireless AP of a set of multiple second wireless APs, a first frame including an indication associated with sharing a portion of the obtained TXOP with the at least one second wireless AP of the set of multiple second wireless APs, the portion of the obtained TXOP being a shared TXOP for C-TDMA with the set of multiple second wireless APs. In some examples, the TXOP sharing manager 730 is configurable or configured to obtain a response frame from the at least one second wireless AP of the set of multiple second wireless APs, the response frame including an identifier associated with the at least one second wireless AP. In some examples, the TXOP sharing manager 730 is configurable or configured to share the portion of the obtained TXOP with the at least one second wireless AP for communication in accordance with obtaining the response frame including the identifier associated with the at least one second wireless AP.

In some examples, the first frame includes one or more fields, amongst a set of multiple receiver specific fields, intended for the at least one second wireless AP indicating the portion of the obtained TXOP.

In some examples, the indication associated with sharing the portion of the obtained TXOP includes an indication of a stream classification service (SCS), an estimated timing of a TXOP allocation frame, an estimated length of the portion of the obtained TXOP, or an estimated length of the obtained TXOP, or any combination thereof.

In some examples, the indication associated with sharing the portion of the obtained TXOP includes a query to determine interest of the at least one second wireless AP of the set of multiple second wireless APs to use the portion of the obtained TXOP, an indication of allocating the portion of the obtained TXOP to the at least one second wireless AP of the set of multiple second wireless APs, or both.

In some examples, identifier of the at least one second wireless AP is indicated via a transmitter address associated with the at least one second wireless AP.

In some examples, the response frame includes an indication that the at least one second wireless AP will communicate via the portion of the obtained TXOP.

In some examples, the response frame includes an indication of a duration that the at least one second wireless AP will communicate via the portion of the obtained TXOP.

In some examples, the response frame includes an indication of a bandwidth over which the at least one second wireless AP will communicate during the portion of the obtained TXOP.

In some examples, the TXOP sharing manager 730 is configurable or configured to determine a schedule for the set of multiple second wireless APs to communicate during the portion of the obtained TXOP. In some examples, the TXOP sharing manager 730 is configurable or configured to output an indication of the schedule, where the indication of the schedule includes an indication of one or more resource units for the set of multiple second wireless APs to communicate.

In some examples, the one or more resource units include dedicated resource units associated with the set of multiple second wireless APs or a broadcast resource unit dedicated for C-TDMA.

In some examples, the set of multiple wireless devices include one or more wireless stations associated with the first wireless AP.

In some examples, the STA response manager 740 is configurable or configured to receive, from the one or more wireless stations and via a first resource unit indicated by the first frame, a second response frame including a trigger-based physical protocol data unit.

In some examples, the first frame includes at least one of a BSRP frame, a basic trigger frame, a variant of a MU-BAR trigger frame, a MU-RTS trigger frame, or another trigger frame.

Additionally, or alternatively, the wireless communication device 700 may support wireless communication in accordance with examples as disclosed herein. In some examples, the TXOP sharing manager 730 is configurable or configured to obtain a first frame including an indication associated with sharing a portion of a TXOP obtained by a second wireless AP, the portion of the obtained TXOP being a shared TXOP for C-TDMA. In some examples, the TXOP sharing manager 730 is configurable or configured to output a response frame in response to the first frame, the response frame including an identifier associated with the first wireless AP. The STA communication manager 735 is configurable or configured to communicate with one or more wireless stations during the portion of the obtained TXOP in accordance with outputting the response frame including the identifier associated with the first wireless AP.

In some examples, the first frame includes one or more fields, amongst a set of multiple receiver specific fields, intended for the first wireless AP indicating the portion of the obtained TXOP.

In some examples, the indication associated with sharing the portion of the obtained TXOP includes an indication of a stream classification service, an estimated timing of a TXOP allocation frame, an estimated length of the portion of the obtained TXOP, or an estimated length of the obtained TXOP, or any combination thereof.

In some examples, the indication associated with sharing the portion of the obtained TXOP includes a query to first wireless AP to use the portion of the obtained TXOP, an indication of allocating the portion of the obtained TXOP to the first wireless AP, or both.

In some examples, the identifier of the first wireless AP is indicated via a transmitter address associated with the first wireless AP.

In some examples, the response frame includes an indication that the first wireless AP will communicate via the portion of the obtained TXOP.

In some examples, the response frame includes an indication of a duration that the first wireless AP will communicate via the portion of the obtained TXOP.

In some examples, the response frame includes an indication of a bandwidth over which the first wireless AP will communicate during the portion of the obtained TXOP.

In some examples, the TXOP sharing manager 730 is configurable or configured to obtain an indication of a schedule for communicating via the portion of the obtained TXOP, where the indication of the schedule includes an indication of one or more resource units associated with a set of multiple second wireless APs, and where the set of multiple second wireless APs includes the first wireless AP.

In some examples, the one or more resource units include dedicated resource units associated with the set of multiple second wireless APs or a broadcast resource unit dedicated for C-TDMA.

In some examples, the first frame includes at least one of a BSRP frame, a basic trigger frame, a variant of a MU-BAR trigger frame, a MU-RTS trigger frame, or another trigger frame.

FIG. 8 shows a flowchart illustrating an example process 800 performable by or at a first wireless AP that supports schedule announcement enhancements for C-TDMA. The operations of the process 800 may be implemented by a first wireless AP or its components as described herein. For example, the process 800 may be performed by a wireless communication device, such as the wireless communication device 700 described with reference to FIG. 7, operating as or within a wireless AP. In some examples, the process 800 may be performed by a wireless AP, such as one of the APs 102 described with reference to FIG. 1.

In some examples, in 805, the first wireless AP may obtain a TXOP. The operations of 805 may be performed in accordance with examples as disclosed herein. In some implementations, aspects of the operations of 805 may be performed by a TXOP obtaining manager 725 as described with reference to FIG. 7.

In some examples, in 810, the first wireless AP may output, during the obtained TXOP and to a set of multiple wireless devices including at least one second wireless AP of a set of multiple second wireless APs, a first frame including an indication associated with sharing a portion of the obtained TXOP with the at least one second wireless AP of the set of multiple second wireless APs, the portion of the obtained TXOP being a shared TXOP for C-TDMA with the set of multiple second wireless APs. The operations of 810 may be performed in accordance with examples as disclosed herein. In some implementations, aspects of the operations of 810 may be performed by a TXOP sharing manager 730 as described with reference to FIG. 7.

In some examples, in 815, the first wireless AP may obtain a response frame from the at least one second wireless AP of the set of multiple second wireless APs, the response frame including an identifier associated with the at least one second wireless AP. The operations of 815 may be performed in accordance with examples as disclosed herein. In some implementations, aspects of the operations of 815 may be performed by a TXOP sharing manager 730 as described with reference to FIG. 7.

In some examples, in 820, the first wireless AP may share the portion of the obtained TXOP with the at least one second wireless AP for communication in accordance with obtaining the response frame including the identifier associated with the at least one second wireless AP. The operations of 820 may be performed in accordance with examples as disclosed herein. In some implementations, aspects of the operations of 820 may be performed by a TXOP sharing manager 730 as described with reference to FIG. 7.

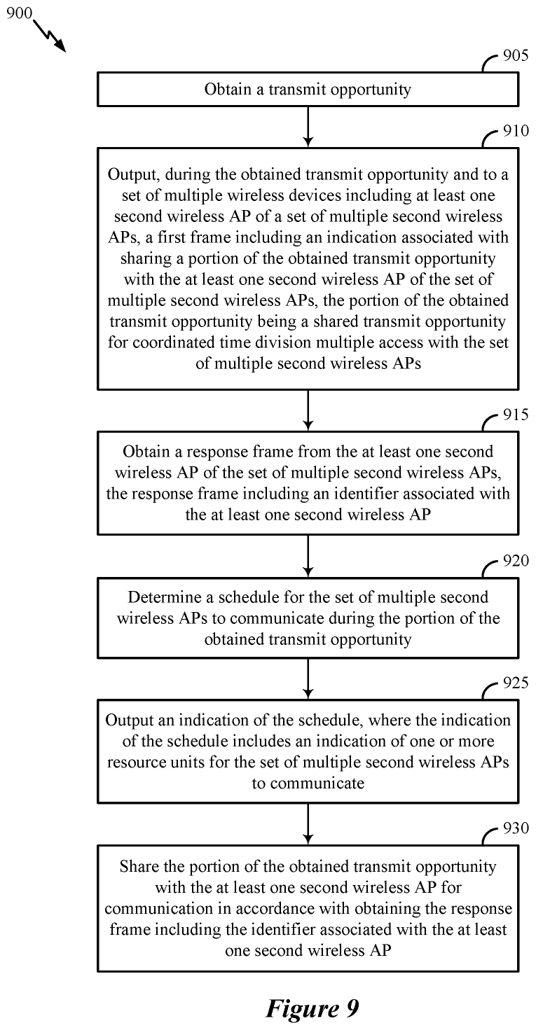

FIG. 9 shows a flowchart illustrating an example process 900 performable by or at a first wireless AP that supports schedule announcement enhancements for C-TDMA. The operations of the process 900 may be implemented by a first wireless AP or its components as described herein. For example, the process 900 may be performed by a wireless communication device, such as the wireless communication device 700 described with reference to FIG. 7, operating as or within a wireless AP. In some examples, the process 900 may be performed by a wireless AP, such as one of the APs 102 described with reference to FIG. 1.

In some examples, in 905, the first wireless AP may obtain a TXOP. The operations of 905 may be performed in accordance with examples as disclosed herein. In some implementations, aspects of the operations of 905 may be performed by a TXOP obtaining manager 725 as described with reference to FIG. 7.

In some examples, in 910, the first wireless AP may output, during the obtained TXOP and to a set of multiple wireless devices including at least one second wireless AP of a set of multiple second wireless APs, a first frame including an indication associated with sharing a portion of the obtained TXOP with the at least one second wireless AP of the set of multiple second wireless APs, the portion of the obtained TXOP being a shared TXOP for C-TDMA with the set of multiple second wireless APs. The operations of 910 may be performed in accordance with examples as disclosed herein. In some implementations, aspects of the operations of 910 may be performed by a TXOP sharing manager 730 as described with reference to FIG. 7.

In some examples, in 915, the first wireless AP may obtain a response frame from the at least one second wireless AP of the set of multiple second wireless APs, the response frame including an identifier associated with the at least one second wireless AP. The operations of 915 may be performed in accordance with examples as disclosed herein. In some implementations, aspects of the operations of 915 may be performed by a TXOP sharing manager 730 as described with reference to FIG. 7.

In some examples, in 920, the first wireless AP may determine a schedule for the set of multiple second wireless APs to communicate during the portion of the obtained TXOP. The operations of 920 may be performed in accordance with examples as disclosed herein. In some implementations, aspects of the operations of 920 may be performed by a TXOP sharing manager 730 as described with reference to FIG. 7.

In some examples, in 925, the first wireless AP may output an indication of the schedule, where the indication of the schedule includes an indication of one or more resource units for the set of multiple second wireless APs to communicate. The operations of 925 may be performed in accordance with examples as disclosed herein. In some implementations, aspects of the operations of 925 may be performed by a TXOP sharing manager 730 as described with reference to FIG. 7.

In some examples, in 930, the first wireless AP may share the portion of the obtained TXOP with the at least one second wireless AP for communication in accordance with obtaining the response frame including the identifier associated with the at least one second wireless AP. The operations of 930 may be performed in accordance with examples as disclosed herein. In some implementations, aspects of the operations of 930 may be performed by a TXOP sharing manager 730 as described with reference to FIG. 7.

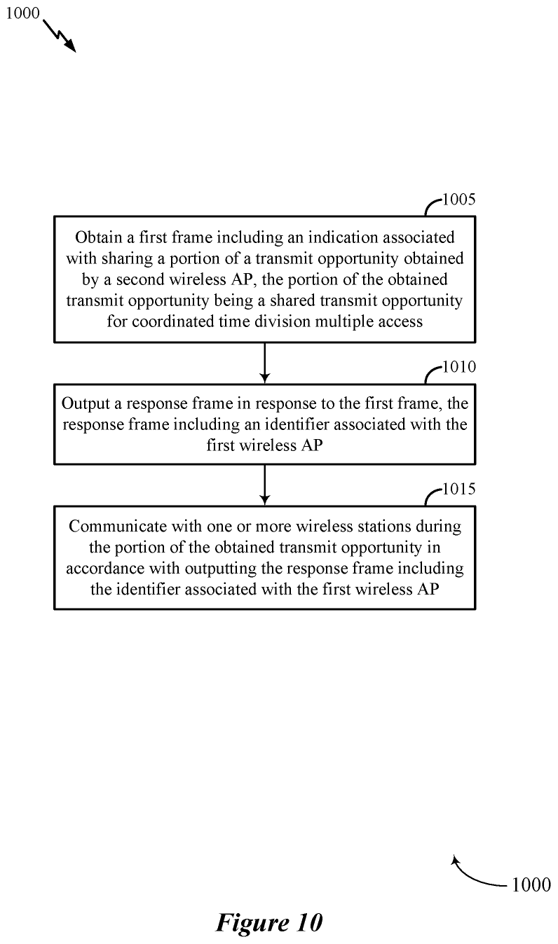

FIG. 10 shows a flowchart illustrating an example process 1000 performable by or at a first wireless AP that supports schedule announcement enhancements for C-TDMA. The operations of the process 1000 may be implemented by a first wireless AP or its components as described herein. For example, the process 1000 may be performed by a wireless communication device, such as the wireless communication device 700 described with reference to FIG. 7, operating as or within a wireless AP. In some examples, the process 1000 may be performed by a wireless AP, such as one of the APs 102 described with reference to FIG. 1.

In some examples, in 1005, the first wireless AP may obtain a first frame including an indication associated with sharing a portion of a TXOP obtained by a second wireless AP, the portion of the obtained TXOP being a shared TXOP for C-TDMA. The operations of 1005 may be performed in accordance with examples as disclosed herein. In some implementations, aspects of the operations of 1005 may be performed by a TXOP sharing manager 730 as described with reference to FIG. 7.

In some examples, in 1010, the first wireless AP may output a response frame in response to the first frame, the response frame including an identifier associated with the first wireless AP. The operations of 1010 may be performed in accordance with examples as disclosed herein. In some implementations, aspects of the operations of 1010 may be performed by a TXOP sharing manager 730 as described with reference to FIG. 7.

In some examples, in 1015, the first wireless AP may communicate with one or more wireless stations during the portion of the obtained TXOP in accordance with outputting the response frame including the identifier associated with the first wireless AP. The operations of 1015 may be performed in accordance with examples as disclosed herein. In some implementations, aspects of the operations of 1015 may be performed by a STA communication manager 735 as described with reference to FIG. 7.

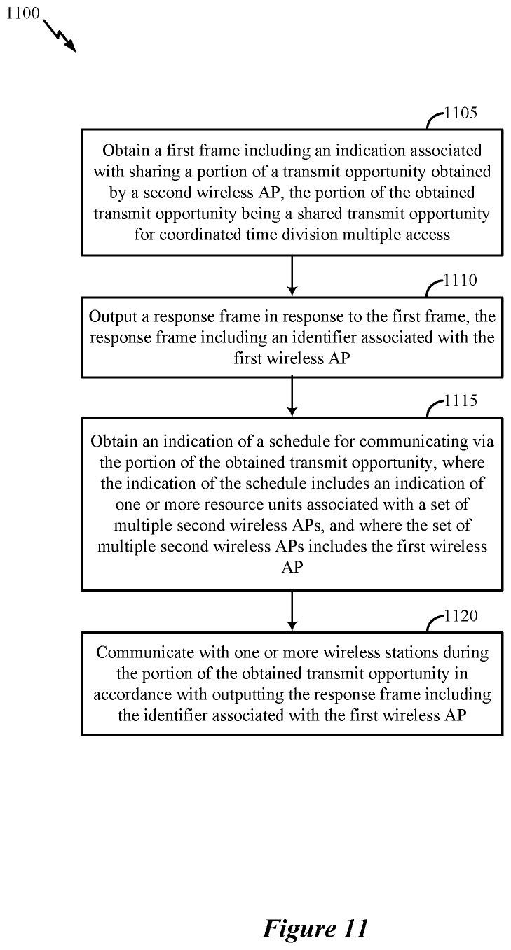

FIG. 11 shows a flowchart illustrating an example process 1100 performable by or at a first wireless AP that supports schedule announcement enhancements for C-TDMA. The operations of the process 1100 may be implemented by a first wireless AP or its components as described herein. For example, the process 1100 may be performed by a wireless communication device, such as the wireless communication device 700 described with reference to FIG. 7, operating as or within a wireless AP. In some examples, the process 1100 may be performed by a wireless AP, such as one of the APs 102 described with reference to FIG. 1.

In some examples, in 1105, the first wireless AP may obtain a first frame including an indication associated with sharing a portion of a TXOP obtained by a second wireless AP, the portion of the obtained TXOP being a shared TXOP for C-TDMA. The operations of 1105 may be performed in accordance with examples as disclosed herein. In some implementations, aspects of the operations of 1105 may be performed by a TXOP sharing manager 730 as described with reference to FIG. 7.

In some examples, in 1110, the first wireless AP may output a response frame in response to the first frame, the response frame including an identifier associated with the first wireless AP. The operations of 1110 may be performed in accordance with examples as disclosed herein. In some implementations, aspects of the operations of 1110 may be performed by a TXOP sharing manager 730 as described with reference to FIG. 7.

In some examples, in 1115, the first wireless AP may obtain an indication of a schedule for communicating via the portion of the obtained TXOP, where the indication of the schedule includes an indication of one or more resource units associated with a set of multiple second wireless APs, and where the set of multiple second wireless APs includes the first wireless AP. The operations of 1115 may be performed in accordance with examples as disclosed herein. In some implementations, aspects of the operations of 1115 may be performed by a TXOP sharing manager 730 as described with reference to FIG. 7.

In some examples, in 1120, the first wireless AP may communicate with one or more wireless stations during the portion of the obtained TXOP in accordance with outputting the response frame including the identifier associated with the first wireless AP. The operations of 1120 may be performed in accordance with examples as disclosed herein. In some implementations, aspects of the operations of 1120 may be performed by a STA communication manager 735 as described with reference to FIG. 7.

Implementation examples are described in the following numbered clauses:

The following provides an overview of aspects of the present disclosure:

Aspect 1: A method for wireless communications by a first wireless AP, comprising: obtaining a TXOP; outputting, during the obtained TXOP and to a plurality of wireless devices comprising at least one second wireless AP of a plurality of second wireless APs, a first frame comprising an indication associated with sharing a portion of the obtained TXOP with the at least one second wireless AP of the plurality of second wireless APs, the portion of the obtained TXOP being a shared TXOP for C-TDMA with the plurality of second wireless APs; obtaining a response frame from the at least one second wireless AP of the plurality of second wireless APs, the response frame comprising an identifier associated with the at least one second wireless AP; and sharing the portion of the obtained TXOP with the at least one second wireless AP for communication in accordance with obtaining the response frame comprising the identifier associated with the at least one second wireless AP.

Aspect 2: The method of aspect 1, wherein the first frame comprises one or more fields, amongst a plurality of receiver specific fields, intended for the at least one second wireless AP indicating the portion of the obtained TXOP.

Aspect 3: The method of aspect 2, wherein the indication associated with sharing the portion of the obtained TXOP comprises an indication of a SCS, an estimated timing of a TXOP allocation frame, an estimated length of the portion of the obtained TXOP, or an estimated length of the obtained TXOP, or any combination thereof.

Aspect 4: The method of any of aspects 2 through 3, wherein an order of the plurality of receiver specific fields is based at least in part on respective wireless devices of the plurality of wireless devices corresponding to respective receiver specific fields of the plurality of receiver specific fields.

Aspect 5: The method of any of aspects 1 through 4, wherein the indication associated with sharing the portion of the obtained TXOP comprises a query to determine interest of the at least one second wireless AP of the plurality of second wireless APs to use the portion of the obtained TXOP, an indication of allocating the portion of the obtained TXOP to the at least one second wireless AP of the plurality of second wireless APs, or both.

Aspect 6: The method of any of aspects 1 through 5, wherein identifier of the at least one second wireless AP is indicated via a TA associated with the at least one second wireless AP.

Aspect 7: The method of any of aspects 1 through 6, wherein the response frame comprises an indication that the at least one second wireless AP will communicate via the portion of the obtained TXOP.

Aspect 8: The method of any of aspects 1 through 7, wherein the response frame comprises an indication of a duration that the at least one second wireless AP will communicate via the portion of the obtained TXOP.

Aspect 9: The method of any of aspects 1 through 8, wherein the response frame comprises an indication of a bandwidth over which the at least one second wireless AP will communicate during the portion of the obtained TXOP.

Aspect 10: The method of any of aspects 1 through 9, further comprising: determining a schedule for the plurality of second wireless APs to communicate during the portion of the obtained TXOP; and outputting an indication of the schedule, wherein the indication of the schedule comprises an indication of one or more resource units for the plurality of second wireless APs to communicate.

Aspect 11: The method of aspect 10, wherein the one or more resource units comprise dedicated resource units associated with the plurality of second wireless APs or a broadcast resource unit dedicated for C-TDMA.

Aspect 12: The method of any of aspects 1 through 11, wherein the plurality of wireless devices comprise one or more wireless stations associated with the first wireless AP.

Aspect 13: The method of aspect 12, further comprising: receiving, from the one or more wireless stations and via a first resource unit indicated by the first frame, a second response frame comprising a trigger-based physical protocol data unit.

Aspect 14: The method of any of aspects 12 through 13, wherein a format of the response frame is different from a format of the second response frame.

Aspect 15: The method of any of aspects 1 through 14, wherein the first frame comprises at least one of a buffer status report poll frame, a basic trigger frame, a variant of a multi-user block address request trigger frame, a multi-user request to send trigger frame, or another trigger frame.

Aspect 16: A method for wireless communications by a first wireless AP, comprising: obtaining a first frame comprising an indication associated with sharing a portion of a TXOP obtained by a second wireless AP, the portion of the obtained TXOP being a shared TXOP for C-TDMA; outputting a response frame in response to the first frame, the response frame comprising an identifier associated with the first wireless AP; and communicating with one or more wireless stations during the portion of the obtained TXOP in accordance with outputting the response frame comprising the identifier associated with the first wireless AP.

Aspect 17: The method of aspect 16, wherein the first frame comprises one or more fields, amongst a plurality of receiver specific fields, intended for the first wireless AP indicating the portion of the obtained TXOP.

Aspect 18: The method of aspect 17, wherein the indication associated with sharing the portion of the obtained TXOP comprises an indication of a SCS, an estimated timing of a TXOP allocation frame, an estimated length of the portion of the obtained TXOP, or an estimated length of the obtained TXOP, or any combination thereof.

Aspect 19: The method of any of aspects 16 through 18, wherein the indication associated with sharing the portion of the obtained TXOP comprises a query to first wireless AP to use the portion of the obtained TXOP, an indication of allocating the portion of the obtained TXOP to the first wireless AP, or both.

Aspect 20: The method of any of aspects 16 through 19, wherein the identifier of the first wireless AP is indicated via a transmitter address associated with the first wireless AP.

Aspect 21: The method of any of aspects 16 through 20, wherein the response frame comprises an indication that the first wireless AP will communicate via the portion of the obtained TXOP.

Aspect 22: The method of any of aspects 16 through 21, wherein the response frame comprises an indication of a duration that the first wireless AP will communicate via the portion of the obtained TXOP.

Aspect 23: The method of any of aspects 16 through 22, wherein the response frame comprises an indication of a bandwidth over which the first wireless AP will communicate during the portion of the obtained TXOP.

Aspect 24: The method of any of aspects 16 through 23, further comprising: obtaining an indication of a schedule for communicating via the portion of the obtained TXOP, wherein the indication of the schedule comprises an indication of one or more resource units associated with a plurality of second wireless APs, and wherein the plurality of second wireless APs comprises the first wireless AP.

Aspect 25: The method of aspect 24, wherein the one or more resource units comprise dedicated resource units associated with the plurality of second wireless APs or a broadcast resource unit dedicated for C-TDMA.

Aspect 26: The method of any of aspects 16 through 25, wherein the first frame comprises at least one of a buffer status report poll frame, a basic trigger frame, a variant of a multi-user block address request trigger frame, a multi-user request to send trigger frame, or another trigger frame.

Aspect 27: A first wireless AP for wireless communications, comprising one or more memories storing processor-executable code, and one or more processors coupled with the one or more memories and individually or collectively operable to execute the code to cause the first wireless AP to perform a method of any of aspects 1 through 15.

Aspect 28: A first wireless AP for wireless communications, comprising at least one means for performing a method of any of aspects 1 through 15.

Aspect 29: A non-transitory computer-readable medium storing code for wireless communications, the code comprising instructions executable by one or more processors to perform a method of any of aspects 1 through 15.

Aspect 30: A first wireless AP for wireless communications, comprising one or more memories storing processor-executable code, and one or more processors coupled with the one or more memories and individually or collectively operable to execute the code to cause the first wireless AP to perform a method of any of aspects 16 through 26.

Aspect 31: A first wireless AP for wireless communications, comprising at least one means for performing a method of any of aspects 16 through 26.

Aspect 32: A non-transitory computer-readable medium storing code for wireless communications, the code comprising instructions executable by one or more processors to perform a method of any of aspects 16 through 26.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless access point (AP), comprising:
a processing system that includes processor circuitry and memory circuitry that stores code, the processing system configured to cause the first wireless AP to:
obtain a transmit opportunity;
output, during the obtained transmit opportunity and to a plurality of wireless devices comprising at least one second wireless AP of a plurality of second wireless APs, a first frame comprising an indication associated with sharing a portion of the obtained transmit opportunity with the at least one second wireless AP of the plurality of second wireless APs, the portion of the obtained transmit opportunity being a shared transmit opportunity for coordinated time division multiple access with the plurality of second wireless APs;
obtain a response frame from the at least one second wireless AP of the plurality of second wireless APs, the response frame comprising an identifier associated with the at least one second wireless AP; and
share the portion of the obtained transmit opportunity with the at least one second wireless AP for communication in accordance with obtaining the response frame comprising the identifier associated with the at least one second wireless AP.

2. The first wireless AP of claim 1, wherein the first frame comprises one or more fields, amongst a plurality of receiver specific fields, intended for the at least one second wireless AP indicating at least the portion of the obtained transmit opportunity.

3. The first wireless AP of claim 2, wherein the indication associated with sharing the portion of the obtained transmit opportunity comprises an indication of a stream classification service, an estimated timing of a transmit opportunity allocation frame, an estimated length of the portion of the obtained transmit opportunity, or an estimated length of the obtained transmit opportunity, or any combination thereof.

4. The first wireless AP of claim 1, wherein the indication associated with sharing the portion of the obtained transmit opportunity comprises a query to determine interest of the at least one second wireless AP of the plurality of second wireless APs to use the portion of the obtained transmit opportunity, an indication of allocating the portion of the obtained transmit opportunity to the at least one second wireless AP of the plurality of second wireless APs, or both.

5. The first wireless AP of claim 1, wherein identifier of the at least one second wireless AP is indicated via a transmitter address associated with the at least one second wireless AP.

6. The first wireless AP of claim 1, wherein the response frame comprises an indication that the at least one second wireless AP will communicate via the portion of the obtained transmit opportunity.

7. The first wireless AP of claim 1, wherein the response frame comprises an indication of a duration that the at least one second wireless AP will communicate via the portion of the obtained transmit opportunity.

8. The first wireless AP of claim 1, wherein the response frame comprises an indication of a bandwidth over which the at least one second wireless AP will communicate during the portion of the obtained transmit opportunity.

9. The first wireless AP of claim 1, wherein the processing system is further configured to cause the first wireless AP to:
determine a schedule for the plurality of second wireless APs to communicate during the portion of the obtained transmit opportunity; and
output an indication of the schedule, wherein the indication of the schedule comprises an indication of one or more resource units for the plurality of second wireless APs to communicate.

10. The first wireless AP of claim 9, wherein the one or more resource units comprise dedicated resource units associated with the plurality of second wireless APs or a broadcast resource unit dedicated for coordinated time division multiple access.

11. The first wireless AP of claim 1, wherein the plurality of wireless devices comprise one or more wireless stations associated with the first wireless AP.

12. The first wireless AP of claim 11, wherein the processing system is further configured to cause the first wireless AP to:
receive, from the one or more wireless stations and via a first resource unit indicated by the first frame, a second response frame comprising a trigger-based physical protocol data unit.

13. The first wireless AP of claim 1, wherein the first frame comprises at least one of a buffer status report poll frame, a basic trigger frame, a variant of a multi-user block address request trigger frame, a multi-user request to send trigger frame, or another trigger frame.

14. A first wireless access point (AP), comprising:
a processing system that includes processor circuitry and memory circuitry that stores code, the processing system configured to cause the first wireless AP to:
obtain a first frame comprising an indication associated with sharing a portion of a transmit opportunity obtained by a second wireless AP, the portion of the obtained transmit opportunity being a shared transmit opportunity for coordinated time division multiple access;
output a response frame in response to the first frame, the response frame comprising an identifier associated with the first wireless AP; and
communicate with one or more wireless stations during the portion of the obtained transmit opportunity in accordance with outputting the response frame comprising the identifier associated with the first wireless AP.

15. The first wireless AP of claim 14, wherein the first frame comprises one or more fields, amongst a plurality of receiver specific fields, intended for the first wireless AP indicating at least the portion of the obtained transmit opportunity.

16. The first wireless AP of claim 15, wherein the indication associated with sharing the portion of the obtained transmit opportunity comprises an indication of a stream classification service, an estimated timing of a transmit opportunity allocation frame, an estimated length of the portion of the obtained transmit opportunity, or an estimated length of the obtained transmit opportunity, or any combination thereof.

17. The first wireless AP of claim 14, wherein the indication associated with sharing the portion of the obtained transmit opportunity comprises a query to first wireless AP to use the portion of the obtained transmit opportunity, an indication of allocating the portion of the obtained transmit opportunity to the first wireless AP, or both.

18. The first wireless AP of claim 14, wherein the identifier of the first wireless AP is indicated via a transmitter address associated with the first wireless AP.

19. The first wireless AP of claim 14, wherein the processing system is further configured to cause the first wireless AP to:
obtain an indication of a schedule for communicating via the portion of the obtained transmit opportunity, wherein the indication of the schedule comprises an indication of one or more resource units associated with a plurality of second wireless APs, and wherein the plurality of second wireless APs comprises the first wireless AP.

20. A method for wireless communication by a first wireless access point (AP), comprising:
obtaining a transmit opportunity;
outputting, during the obtained transmit opportunity and to a plurality of wireless devices comprising at least one second wireless AP of a plurality of second wireless APs, a first frame comprising an indication associated with sharing a portion of the obtained transmit opportunity with the at least one second wireless AP of the plurality of second wireless APs, the portion of the obtained transmit opportunity being a shared transmit opportunity for coordinated time division multiple access with the plurality of second wireless APs;
obtaining a response frame from the at least one second wireless AP of the plurality of second wireless APs, the response frame comprising an identifier associated with the at least one second wireless AP; and
sharing the portion of the obtained transmit opportunity with the at least one second wireless AP for communication in accordance with obtaining the response frame comprising the identifier associated with the at least one second wireless AP.
